(19) United States
(12) Patent Application Publication
(10) Pub. No.: US 2011/0304481 A1
(43) Pub. Date: Dec. 15, 2011

(54) SYSTEM AND METHOD FOR VEHICLE IDENTIFICATION

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/851,528

(22) Filed: Aug. 5, 2010

(30) Foreign Application Priority Data
Jun. 9, 2010 (TW) 99118646

(51) Int. Cl. G08G 1/123

(52) U.S. Cl. 340/989

(57) ABSTRACT

A vehicle identification system includes a vehicle identification information extraction unit to extract vehicle identification information of a vehicle, a network unit, a vehicle identification information checking unit, a locating unit, and a matching unit. The vehicle identification information checking unit communicates with a missing vehicle database through the network unit, and compares the extracted vehicle identification information of the vehicle against the missing vehicle database. The locating unit detects a location signal, when the extracted vehicle identification information and the missing vehicle database achieve a match. The matching unit combines the image of the vehicle with the location signal and records the combined vehicle information, subsequently transmits the combined vehicle information to an inquiry of missing vehicle database through the network unit.

### BACKGROUND

1. Technical Field

Embodiments of the present disclosure relate to database access, and more particularly, to a system and a method for vehicle identification based on a database.

2. Description of Related Art

A typical vehicle identification system includes a keyboard and display. The keyboard allows input of vehicle identification information of a vehicle and the system checks for the details in a missing vehicle database. The inquiry result appears on the display. However, input of the vehicle identification information of the vehicle is accomplished manually and thus may be prone to error.

Therefore, what is called for is a system and method for vehicle identification to address the limitations described.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a block diagram of an exemplary embodiment of a vehicle identification system.

FIG. 2 is a schematic view of a display providing an image from the vehicle identification system of FIG. 1.

FIG. 3 is a block diagram of the vehicle identification system connecting to a missing vehicle database, an inquiry missing vehicle database, and a terminal device.

FIG. 4 is a flowchart of an exemplary embodiment of a vehicle identification method.

### DETAILED DESCRIPTION

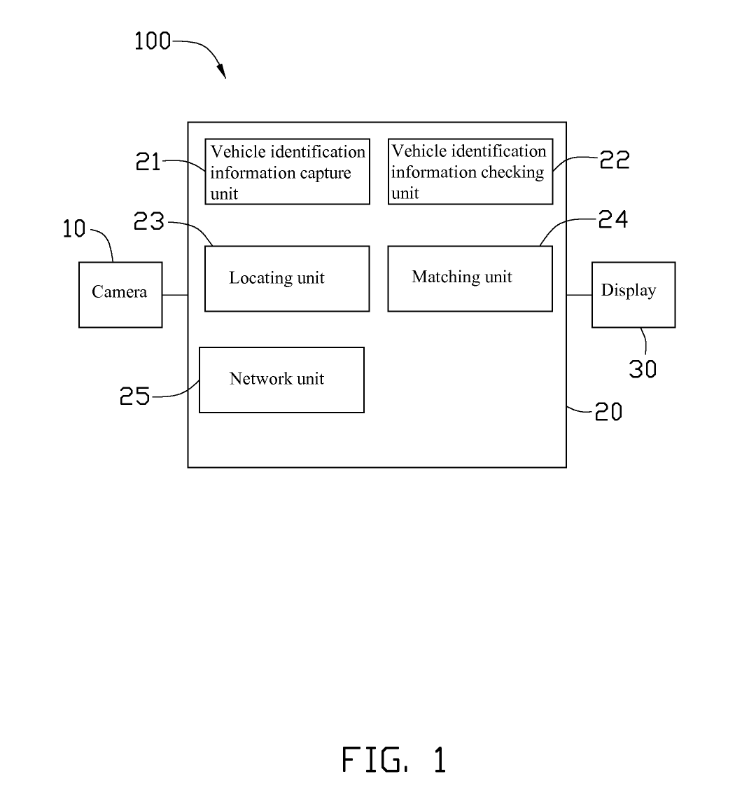

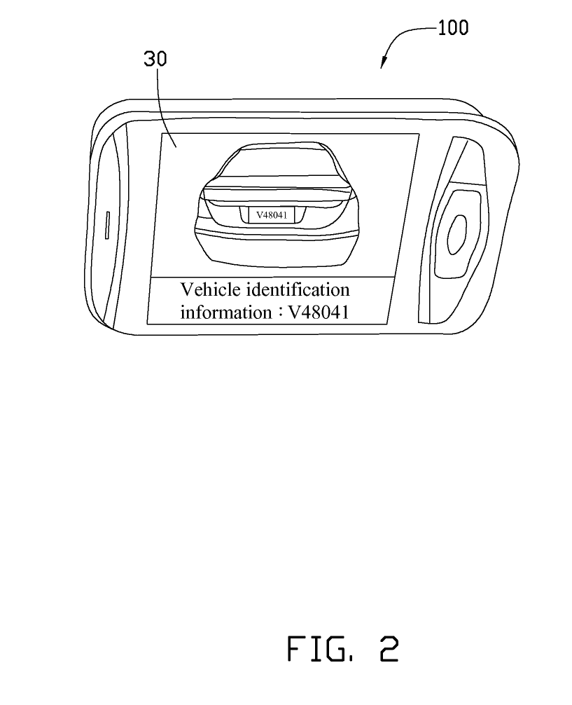

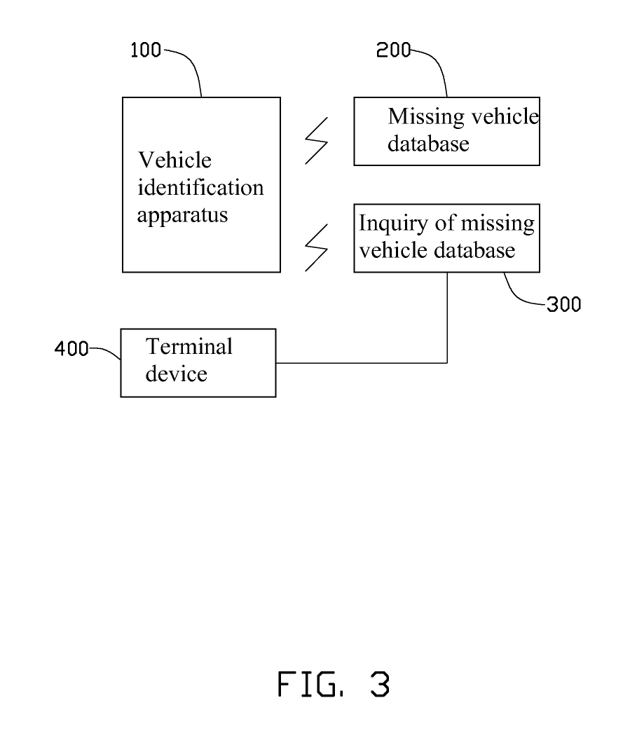

Referring to FIGS. 1-3, an exemplary embodiment of a vehicle identification apparatus 100 includes a camera 10, a vehicle identification system 20, and a display 30.

The camera 10 captures an image of a vehicle.

The display 30 displays the image from the camera 10.

The vehicle identification system 20 includes a vehicle identification information capture unit 21, a vehicle identification information checking unit 22, a locating unit 23, a matching unit 24, and a network unit 25. The vehicle identification information capture unit 21 extracts vehicle identification information from the image of the vehicle from the camera 10. The vehicle identification information checking unit 22 communicates wirelessly with a missing vehicle database 200 through the network unit 25, and submits the captured vehicle identification information to the vehicle identification information capture unit 21 (hereafter called captured vehicle identification information) against the missing vehicle database 200. Data of the missing vehicle database 200 may be provided by police or other agency. When the captured vehicle identification information and the data of the missing vehicle database 200 achieve a match, the locating unit 23 detects a location signal (longitude, latitude, and altitude) of the vehicle. In the illustrated embodiment, the locating unit 23 may be a global positioning system (GPS). The matching unit 24 combines the image of the vehicle with the location signal and records these vehicle information. The network unit 25 transmits the vehicle information to an inquiry of missing vehicle database 300, updating the records thereof. A terminal device 400 communicates with the inquiry of missing vehicle database 300 through wireless or wired networking. Any vehicle identification information of a vehicle can be input for inquiry on the terminal device 400, and when the vehicle identification information of the vehicle and data of the inquiry of missing vehicle database 300 achieve a match, the terminal device 400 displays the vehicle information. The terminal device 400 may for example be a cell phone or a computer. The terminal device 400 may further include an inquiry charge system. The inquiry charge system calculates fees according to the number of inquiries.

In use, the camera 10 captures an image of the vehicle, which is shown on display 30. The vehicle identification information capture unit 21 extracts the vehicle identification information of the vehicle. The vehicle identification information checking unit 22 compares extracted vehicle identification information against the missing vehicle database 200. When the captured vehicle identification information and the data of the missing vehicle database 200 achieve a match, and the locating unit 23 detects the location signal of the vehicle. The matching unit 24 combines the image of the vehicle with the location signal and records the vehicle information. The network unit 25 transmits the vehicle information to the inquiry of missing vehicle database 300. Vehicle identification information of the vehicle for inquiring missing vehicles is input to the terminal device 400, and when the vehicle identification information of the vehicle and the data of the inquiry of missing vehicle database 300 achieve a match, the terminal device 400 displays the vehicle information.

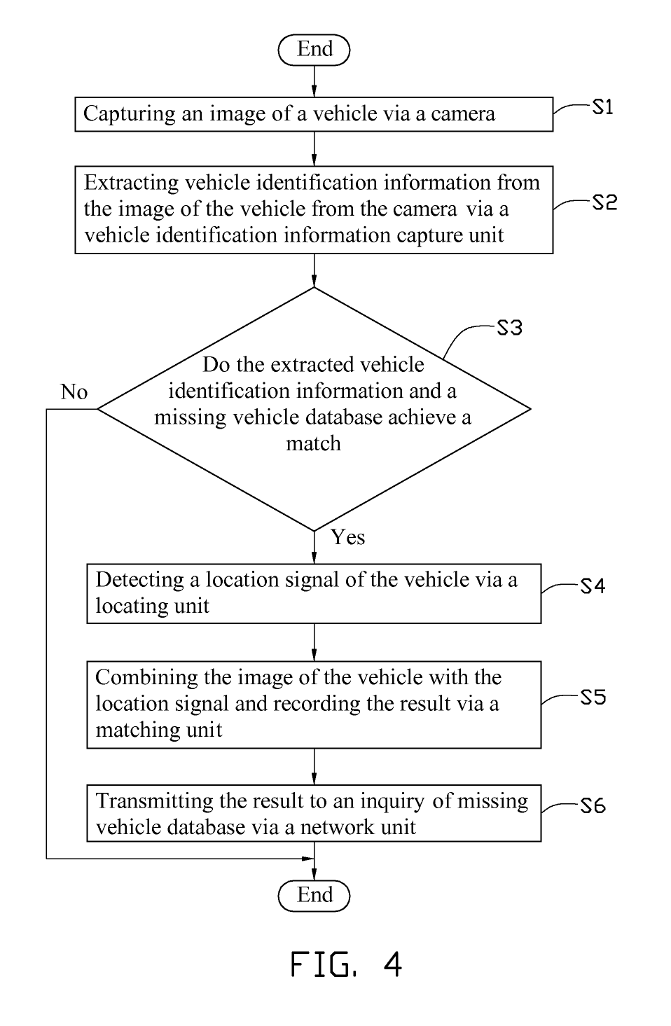

Referring to FIG. 4, a vehicle identification method is provided, as follows.

In step S1, the camera 10 captures an image of the vehicle.

In step S2, the vehicle identification information capture unit 21 extracts the vehicle identification information from the image of the vehicle from the camera 10.

In step S3, the vehicle identification information checking unit 22 compares the captured vehicle identification information against the missing vehicle database 200; if a match is achieved, step S4 is implemented; if not, the process ends.

In step S4, the locating unit 23 detects the location signal (longitude, latitude, and altitude) of the vehicle.

In step S5, the matching unit 24 combines the image of the vehicle with the location signal and records the vehicle information.

In step S6, the network unit 25 transmits the vehicle information to the inquiry of missing vehicle database 300.

While the invention has been described by way of example and in terms of embodiments, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A vehicle identification system, comprising:
a vehicle identification information extraction unit to extract vehicle identification information of a vehicle;
a network unit;
a vehicle identification information checking unit to communicate with a missing vehicle database through the network unit, and further compare the extracted vehicle identification information of the vehicle against the missing vehicle database;
a locating unit operable to detect a location signal when the extracted vehicle identification information and the missing vehicle database achieve a match; and
a matching unit to combine the image of the vehicle with the location signal and record the combined vehicle information, subsequently transmit the combined vehicle information to an inquiry of missing vehicle database through the network unit.

2. The vehicle identification system of claim 1, wherein the locating unit is a global positioning system (GPS).

3. The vehicle identification system of claim 1, wherein the location signal comprises longitude, latitude, or altitude of the vehicle.

4. The vehicle identification system of claim 1, further comprising an image-capturing unit to capture an image of the vehicle, wherein the vehicle identification information of the vehicle is extracted form the image.

5. A method for vehicle identification, comprising:
capturing an image of a vehicle via a camera;
a vehicle identification information capture unit extracting vehicle identification information from the image of the vehicle from the camera;
a vehicle identification information checking unit determining whether the extracted vehicle identification information and a missing vehicle database achieve a match;
if a match is achieved, a locating unit detecting a location signal of the vehicle;
a matching unit combining the image of the vehicle with the location signal and recording the combined vehicle information; and
transmitting the combined vehicle information to an inquiry of missing vehicle database via a network unit.

6. The method of claim 5, wherein the locating unit is a global positioning system (GPS).

7. The method of claim 5, wherein the location signal comprises longitude, latitude, or altitude of the vehicle.
